(19) United States
(12) Patent Application Publication
(10) Pub. No.: US 2005/0175206 A1
(43) Pub. Date: Aug. 11, 2005

(54) Loudspeaker assembly having a folded bifurcated vent tube

(76) Inventor: Deon Bearden, Fishers, IN (US)

Correspondence Address: BINGHAM MCHALE LLP, 2700 MARKET TOWER, 10 WEST MARKET STREET, INDIANAPOLIS, IN, 46204-4900, US

(21) Appl. No.: 10/774,022

(22) Filed: Feb. 6, 2004

(51) Int. Cl. H04R 1/02; H04R 1/20

(52) U.S. Cl. 381/338; 381/337; 381/339

(57) ABSTRACT

A vented speaker system including a rectangular speaker box having a top wall and an opposing bottom wall, a front wall and an opposing back wall, and a pair of opposing sidewalls and a vent formed in the front wall. A speaker is positioned within the speaker box and mounted to the front wall. A flanged or otherwise folded vent tube is disposed within the speaker box, fluidically connecting the interior of the box to the exterior of the box. The system is tuned to a lower frequency by extending the effective path length of the vent tube longer than the maximum linear dimension available within the enclosure.

### TECHNICAL FIELD OF THE INVENTION

The present invention relates generally to sound reproduction and, more particularly, to vented loudspeakers.

### BACKGROUND OF THE INVENTION

A vented loudspeaker is a speaker assembly including a speaker mounted within a housing or enclosure. The enclosure typically has an aperture formed therethrough, and the enclosure is connected to a vent tube extending thereinto, such that the low frequency output of the loudspeaker may be augmented by sound generated by the vented speaker via a Helmholtz resonance effect. The vent tube is connected to the aperture and extends into the speaker with the interior end of the vent tube open to allow free flow of air into and out of the speaker. The air within the vent tube acts as a spring, oscillating back and forth. The length and diameter of the vent gives this “air spring” a specific mass, and that mass is coupled to the area of the opening to define the frequency of resonance. At resonance, the inertance of the vent resonates with the compliance of the air in the speaker enclosure, thus allowing the system to act as an acoustic impedance transformer, presenting a high impedance to the rear of the speaker enclosure and a low impedance to the exterior air. Thus, low frequency sound is generated by the vent and supplements the loudspeaker output in the lower frequency range, thereby providing increased system output at lower frequencies.

The function of the port is to substantially increase sound pressure and decrease system distortion at or near the resonant frequency the system. The sound pressure is increased with the increase in the volume of air displaced at resonance. The port accomplishes this by increasing the acoustic load in the port enclosure, which in turn reduces the motion of the driver. For a port of a given length, a larger port cross-sectional area yields a higher volume of displacement for a given air speed. An increased volume displacement leads to a reduction in air velocity at the same sound pressure, and thus a reduction of distortion from the port.

For a desired resonant frequency, the length of the tube generally varies as a function of the volume of the enclosure. For a tube having a specific circular cross-sectional area, the relationship of the tube dimensions and the enclosure volume may be expressed as follows:
Lᵥ=[(1.463×10⁷R²)/(f_{B}V_{B})]−1.463(R)
where Lᵥ is the length of the tube in inches, R is the radius of the tube in inches, V_{B} is the volume of the enclosure in cubic inches, and f_{B} is the tuning frequency (specifically, the Helmholtz resonance center frequency) in Hz. From this expression, it is apparent that the length of the tube is proportional to the square of its radius and is inversely proportional to the volume of the enclosure and the tuning frequency. (See Loud Speaker Design Cookbook, 6^{th} Ed., by Vance Dickason, published by Audio Amateur Express, 2000.)

Traditionally, the internal volume of the enclosure and the maximum length available for the circular port have defined the lowest frequency to which the enclosure may be tuned for a given port cross-sectional area. For a given enclosure size and desired tuning frequency, the length of the port tube must be increased with the square of its radius. The size and/or shape of the speaker must be manipulated to allow for an increased vent tube length and radius. However, factors such as space, expense, consumer demand and the like are practical limitations on the desired size of speaker enclosures.

Thus far, increasing the size of the enclosure, varying the shape of the enclosure to provide more room therein to extend the vent tube, and/or orienting the vent tubes along an internal diagonal in the speaker box to maximize the available tube length have addressed radius maximization. While these approaches have yielded some success regarding maximizing the radius of the vent tube, they do not address the trend for speakers to be made increasingly smaller. Thus, there remains a need for a vented speaker system that allows for an increased vent tube length without correspondingly increasing the interior dimensions of the speaker enclosure. The present invention addresses this need.

### SUMMARY OF THE INVENTION

The present invention relates to a vented loudspeaker, including an enclosure in the form of a rectangular parallelepiped and having a maximum enclosed linear dimension. The enclosure has a vent aperture formed therein. A flanged or otherwise folded vent tube extends from the aperture into the enclosure. The first end of the vent tube is fluidically connected to the vent aperture and the tube has an effective length greater than that of a line extending between its two ends. The end flange incorporates the interior walls of the enclosure as part of the vent tube, effectively folding the vent tube within the enclosure volume. Thus, the effective length of the vent tube is greater than the maximum enclosed linear dimension.

One object of the present invention is to provide an improved vented loudspeaker. Related objects and advantages of the present invention will be apparent from the following description.

### BRIEF DESCRIPTION OF THE DRAWINGS

FIG. 1 is a cutaway perspective view of a first embodiment vented loudspeaker of the present invention.

FIG. 2A is a side perspective side view of a first embodiment vented loudspeaker of the present invention.

FIG. 2B is a partial cutaway perspective view FIG. 2A.

FIG. 3 is a front elevation view of the embodiment of FIG. 1.

FIG. 4 is a cutaway side view of a second embodiment vented loudspeaker of the present invention.

FIG. 5 is a partial cutaway perspective view of the embodiment of FIG. 4.

FIG. 6 is a second cutaway side view of the embodiment of FIG. 4.

FIG. 7 is a perspective view of a folded vent tube used in the embodiment of FIGS. 4-6.

FIG. 8 is a cutaway side view of a third embodiment vented loudspeaker of the present invention.

FIG. 9 is a partial cutaway perspective view of the embodiment of FIG. 8.

FIG. 10 is a cutaway perspective view of a fourth embodiment of the present invention.

FIG. 11 is a cutaway perspective view of a fifth embodiment of the present invention.

FIG. 12 is a partial enlarged view of the helical vent tube of the fourth and fifth embodiments.

### DETAILED DESCRIPTION OF THE PREFERRED EMBODIMENT

For the purposes of promoting an understanding of the principles of the invention and presenting its currently understood best mode of operation, reference will now be made to the embodiments illustrated in the drawings and specific language will be used to describe the same. It will nevertheless be understood that no limitation of the scope of the invention is thereby intended, with such alterations and further modifications in the illustrated device and such further applications of the principles of the invention as illustrated therein being contemplated as would normally occur to one skilled in the art to which the invention relates.

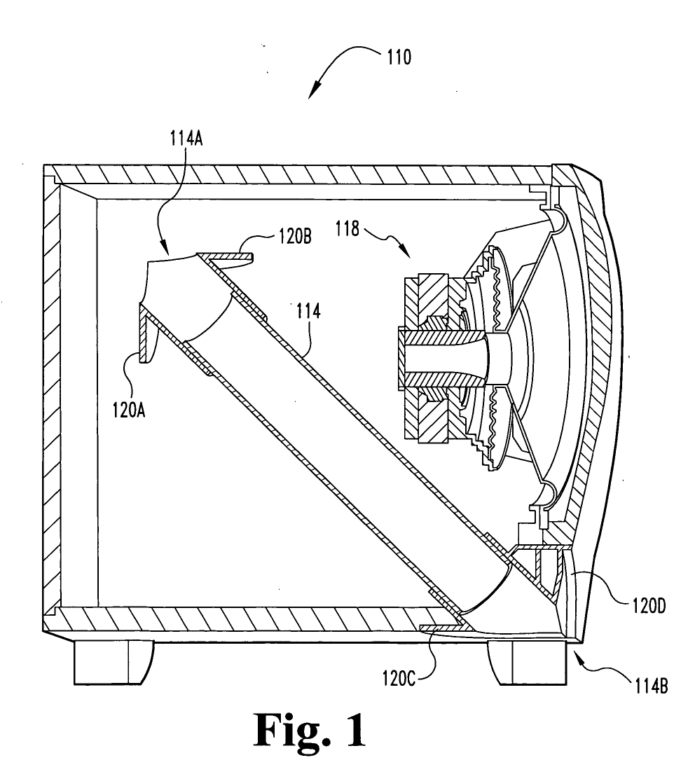

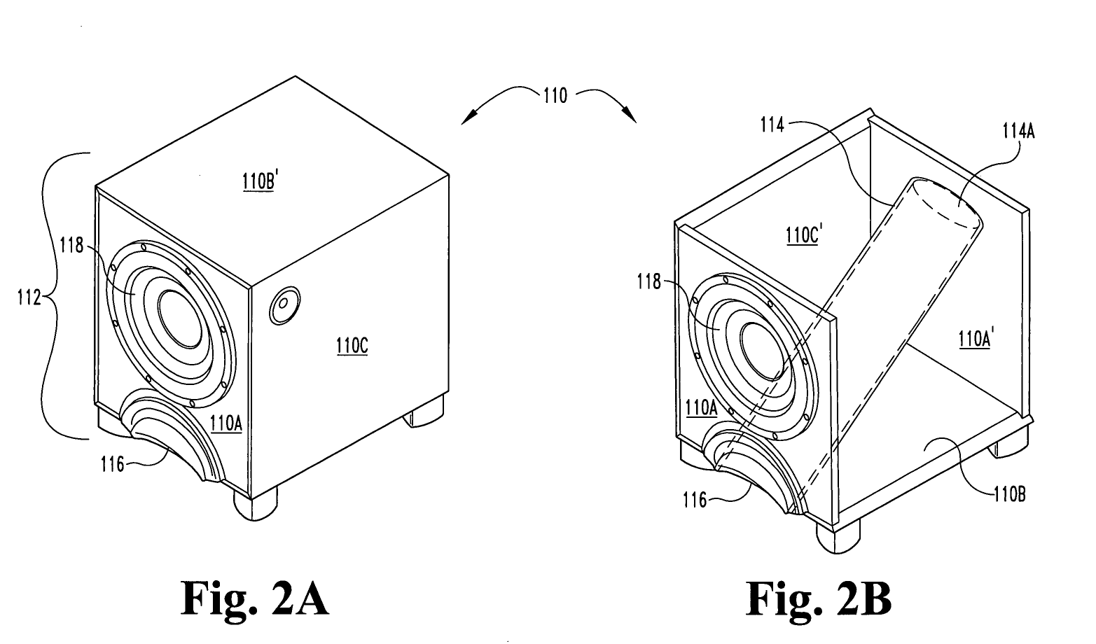

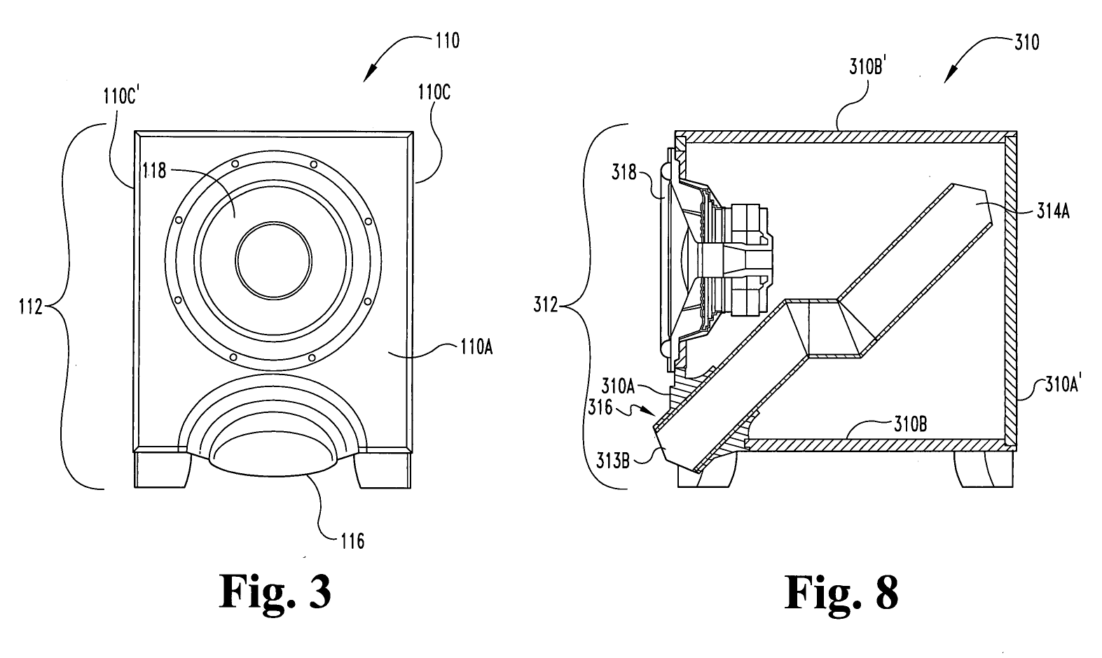

A first preferred embodiment of the present invention is illustrated in FIGS. 1-3, and relates to a vented loudspeaker 110 including a speaker box or cabinet 112 defining an enclosure with a port tube or channel 114 disposed therein. The speaker box 112 is preferably in the shape of a rectangular parallelepiped, but may, alternately, have any convenient shape. In other words, the speaker box 112 is preferably defined by 3 pairs of generally parallel generally flat generally rectangular opposing sides, such as a front-back pair 110A-110A′, a bottom-top pair 110B-110B′, and a right side-left side pair 110C-110C′. An aperture 116 is formed in the speaker box 112. The port channel 114 is fluidically connected to the aperture 116, allowing fluids such as air to enter and exit the otherwise substantially enclosed speaker box 112 through the port channel 114. The aperture 116 is preferably positioned in a corner defined by at least two intersecting sides of the speaker box 112.

Preferably, the port channel 114 is oriented such that it “bisects” the corners at a predetermined angle, preferably between 30 and 50 degrees and more preferably 45 degrees, so as to maximize its corner loading effect and therefore to enable the enclosed volume defined by the port channel 114 to be increased in size relative to a normal configuration. This has the effect of decreasing sound distortion and compression relative to other speakers tuned to the same frequency and lacking such extended vent configurations. Further, the port channel 114 allows a given speaker box size to be tuned to a lower frequency for a given port cross-sectional area (i.e. Lᵥ is proportional to 1/f_{B}).

At least one large flange 120 is disposed on each end of the channel 114. Each flange 120 is disposed on a respective end of the port channel 114 to act, in combination with the interior walls of the speaker enclosure 112, to increase the “effective” length of the port channel 114 such that the port channel 114 is, in effect, greater than its physical length. This is achieved in part by the effective bifurcation and folding of the port channel 114 along the top and rear walls of the enclosure 112. In other words, each flange 120 effectively couples the port channel 114 to one of the walls 110A, 110B or 110C of the enclosure 112, thus incorporating the enclosure walls 110A-C as part of the port channel 114 to increase its effective length. The effective length of the port channel 114 is still greater than the length of a line extending between the ends 114A and 114B, and is preferably greater than the maximum interior linear dimension of the speaker box 112.

Each flange 120 preferably has an identical shape and serves to distort the shape of the channel 114 to thereby effectively lengthen the port channel 114 and improve the second harmonic port distortion by giving a closer impedance match to air entering and exiting the port channel 114. In this first embodiment, the port channel 114 is preferably a substantially linear or straight tube, although in other embodiments the port channel may be substantially non-linear.

In particular, flanges 120A and 120B and flanges 120C and 120D, are disposed on each side of each end 114A and 114B, respectively, of the port channel 114. Flanges 120A and 120B are disposed adjacent port end 114A, and flanges 120C and 120D are disposed adjacent port end 114B. The presence of flanges 120 operationally connected to each end of the port channel 114 causes air entering the end 114A of the port channel from within the interior of the speaker box 112 to encounter the same acoustical impedance as air entering end 114B of the port channel 114 from outside of the speaker box 112. This same principle applies to air exiting either end of the port channel 114. Flanges 120A and 120B act, in combination with the top wall 110B and rear wall 110A, respectively, to corner load the port such that area “a” defined between flange 120A and the top wall 110B and the area “b” defined between the flange 120B and the rear wall 110A serve as folded bifurcated extensions of the port channel to increase its “effective” length.

In operation, air entering one end of the channel 114 sees the same, or a substantially similar, acoustical impedance as it does entering from the other end of the channel 114. The same concept applies to air exiting the port channel 114, as the port channel 114 operates in alternating current (AC) fashion. The effective increase in channel tube length afforded by the flanges 120 has the effect of additionally lowering the tuning frequency by some small but perceptible amount and/or allowing for a desired increase in channel tube radius.

In general, this concept allows one to use a smaller speaker box 112 than conventional porting would allow while tuning to the same frequency, as well as improving in-port distortion with a speaker box 112 of a given size and tuning frequency by maximizing the port cross-sectional area.

The first embodiment of the invention further includes a speaker 118, such as a subwoofer, disposed in the front wall thereof. Arranged within the interior of the box is the port channel 114 opening into the box interior at one end 114A. The port channel 114 is effectively folded or bent by the presence of the end flange 120 to increase its effective length within the speaker box enclosure 112. The opposing end 114B of the port channel intersects, and preferably bisects, the corner defined by the intersection of the front wall 110A and bottom wall 110B of the speaker box 110, preferably at a 45 degree angle, while the flanged end 114A is arranged at the same preferred angle of 45 degrees with respect to the top and rear walls 110B′, 110A′, thereby bisecting that corner as well. It is the “corner loading” effect of channel end 114A being arranged such that it bisects the corner at 45 degrees that dramatically increases the effective length of the channel 114 such that it “acts” like it is much longer than it actually is, which substantially increases performance at lower frequencies.

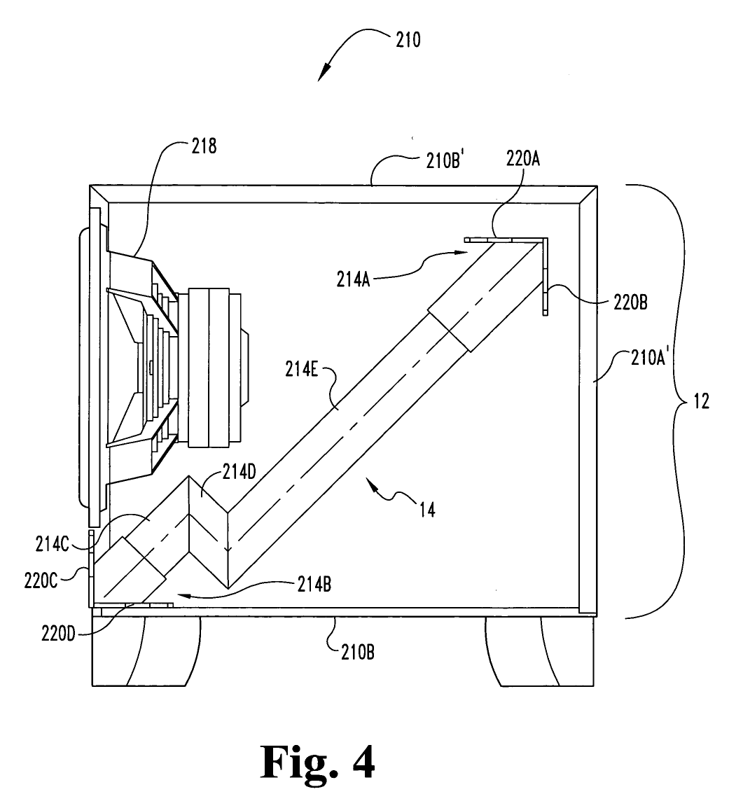

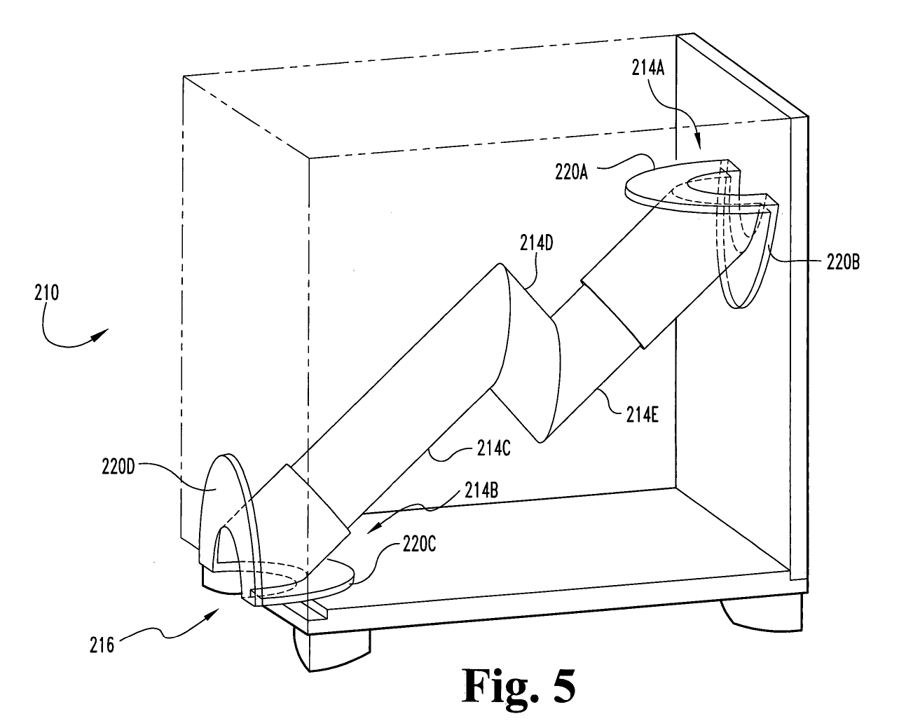

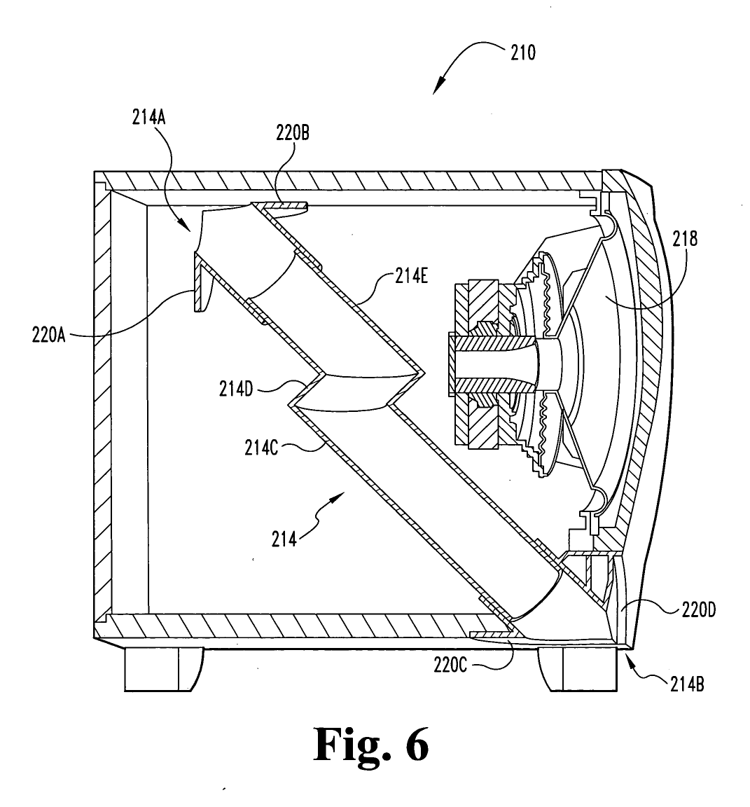

A second embodiment speaker enclosure 210 of the present invention is shown in FIGS. 4-6. This embodiment is similar to the first embodiment discussed above, with the addition of a zig-zag formed in the port channel 214 to further increase its effective length (this time by increasing its actual physical length.) As above, at least one large flange 220 disposed on each end of the channel 214. Each flange 220 is disposed on a respective end of the port channel 214 to act, in combination with the interior walls of the speaker enclosure 212, to increase the “effective” length of the port channel 214 such that the port channel 214 is, in effect, greater than its physical length. As with the first embodiment discussed above, this is achieved in part by the additional bifurcation and folding of the port channel 214 along the top and rear walls of the enclosure 212. Each flange 220 still preferably has an identical shape and serves to distort the shape of the channel 214 to thereby effectively lengthen the port channel 214 and improve the second harmonic port distortion by giving a closer impedance match to air entering and exiting the port channel 214. In this embodiment, the port channel 214 is preferably zigzagged or Z-shaped. The zigzag shape of the port channel 214 better allows for each end to more centrally bisect the enclosure 212 corner at or close to the ideal 45° angle, even if the enclosure 212 does not enjoy the shape of a perfect cube. As noted above, in this embodiment the folded port channel 214 results in the effective length of the channel 214 to be greater than its actual physical length. In other words, the effective length of the port channel 214 is greater than the length of a line extending between both ends 214A, 214B of the port channel 214, and is preferably greater than the maximum length of a line that may be drawn inside the speaker box 212 (i.e., its maximum interior linear dimension).

As in the above first embodiment, the vented loudspeaker 210 includes a speaker box or cabinet 212 defining an enclosure with a zigzagged or Z-shaped port channel 214 disposed therein. The speaker box 212 is preferably in the shape of a rectangular parallelepiped, but may, alternately, have any convenient shape. The speaker box 212 is preferably defined by 3 pairs of generally parallel generally flat generally rectangular opposing sides, such as a front-back pair 210A-210A′, a bottom-top pair 210B-410B′, and a right side-left side pair 210C-210C′. An aperture 216 is formed in the speaker box 212. The port channel 214 is fluidically connected to the aperture 216, allowing fluids such as air to enter and exit the otherwise substantially enclosed speaker box 212 through the port channel 214. The aperture 216 may preferably be positioned in a corner defined by at least two intersecting sides of the speaker box 212.

Preferably, if port channel 214 is oriented such that it “bisects” the corners at a predetermined angle, preferably between 30 and 50 degrees and more preferably 45 degrees, so as to maximize its corner loading effect and therefore to enable the enclosed volume defined by the port channel 214 to be increased in size relative to a normal configuration. This has the effect of decreasing sound distortion and compression relative to other speakers tuned to the same frequency and lacking such extended vent configurations. Further, the Z-shaped port channel 214 allows a given speaker box size to be tuned to a lower frequency for a given port cross-sectional area (i.e. Lᵥ is proportional to 1/f_{B}).

The second preferred embodiment of the present invention further includes a speaker 218, such as a subwoofer, disposed in the front wall thereof. Arranged within the interior of the box is the zigzag or lightning-bolt shaped port channel 214 opening into the box interior at one end 214A. The port channel 214 is folded or bent into a “Z-shape” to increase its effective length within the speaker box enclosure 212. The opposing end 214B of the port channel intersects, and preferably bisects, the corner defined by the intersection of the front wall 210A and bottom wall 210B of the speaker box 210, preferably at a 45 degree angle, while the opposing end 214A is arranged at the same preferred angle of 45 degrees with respect to the top and rear walls 210B′, 210A′, thereby bisecting that corner as well. (See FIG. 4.) It is the “corner loading” effect of channel end 214A being arranged such that it bisects the corner at 45 degrees that dramatically increases the effective length of the channel 214 such that it “acts” like it is much longer than it actually is, which substantially increases performance at lower frequencies.

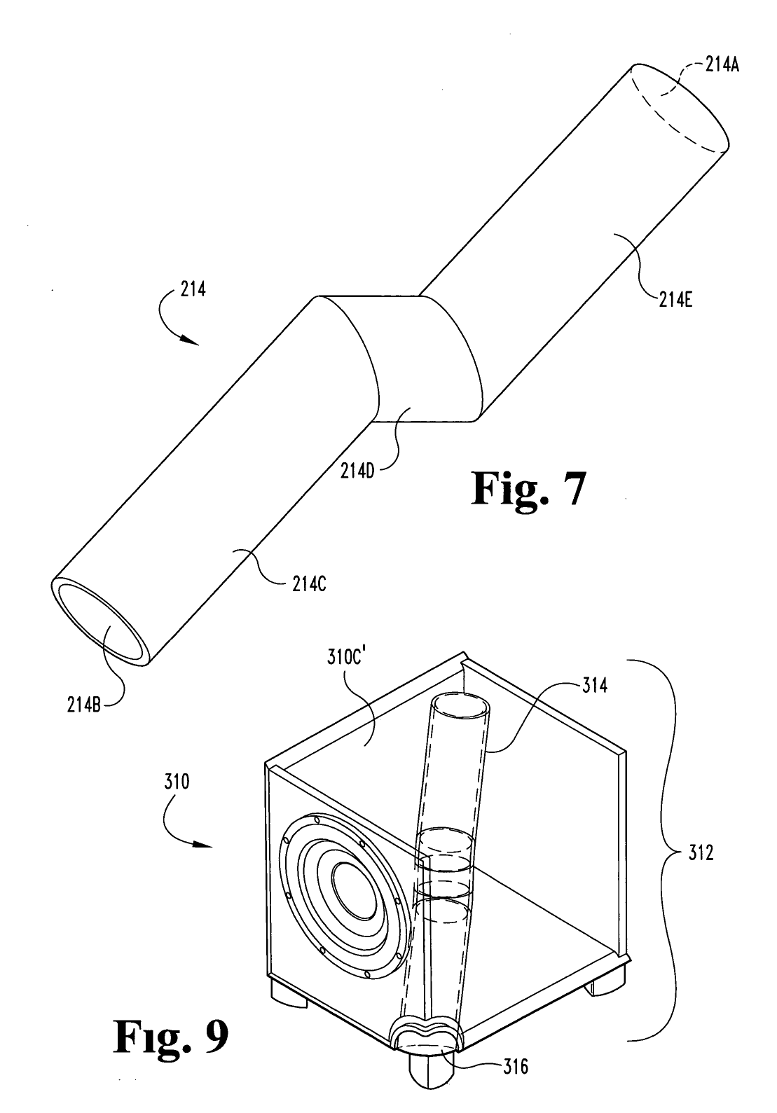

The port channel 214 as shown in greater detail in FIG. 7 includes at least three sections 214C-414E. The middle section 214D is preferably disposed between and connects the end sections 214C and 214E such that the end sections are oriented parallel but non-collinear with each other. The port channel tube 214 may be formed as one unitary piece, or may alternately be comprised of a plurality of connected sections. Preferably, port channel 214 also has an elliptical or circular cross-section, although any convenient cross-sectional geometry may be chosen.

In operation, the bent shape of the channel 214 allows for an increased effective channel length to be positioned inside a finite speaker enclosure volume. This in turn allows for an increased channel tube radius and/or lowered tuning frequency by some small but perceptible amount in accord with the above-mentioned relation.

In a third preferred embodiment of the present invention, shown in FIGS. 8-9, the vented loudspeaker 310 includes a zigzag or lightning-bolt shaped port channel 314 extending from an aperture 316 into the enclosure 310. The aperture 316 may be positioned such that the channel extends generally diagonally from one of the lower corners of the speaker box 312 toward the opposing upper corner. (See FIG. 9.) In this example, port channel 314 extends from an aperture 316 formed in the right front lower corner diagonally toward the left rear upper corner. The port channel 314 may alternately begin and end in any convenient diagonal corner pair. In this embodiment, the port opening 316 is formed at the 3-way corner junction defined by the intersection of the right side wall, the front wall and the bottom wall 310C, 310A, 310B. This arrangement results in the longest straight port channel 314 for a given speaker box size and offset distance from an interior wall of the enclosure 312.

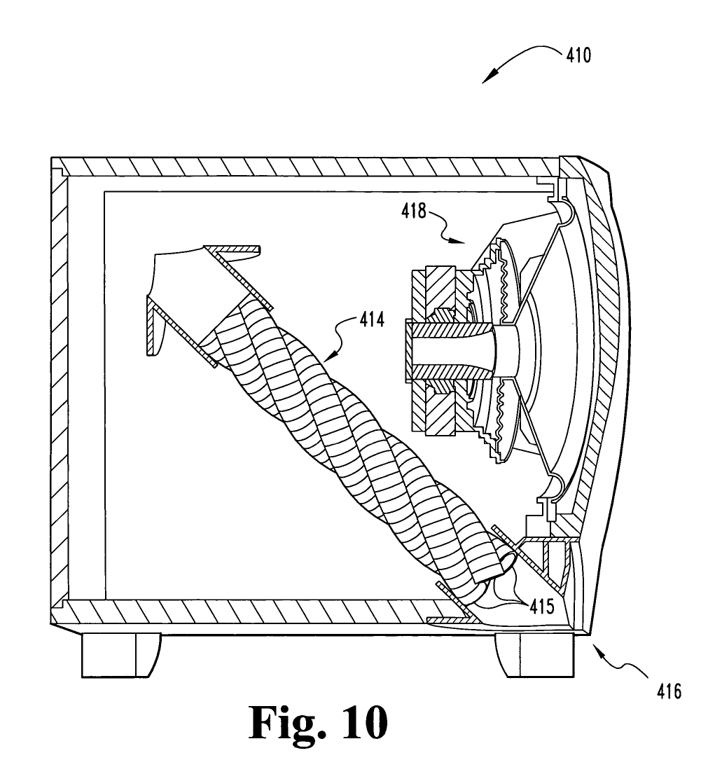

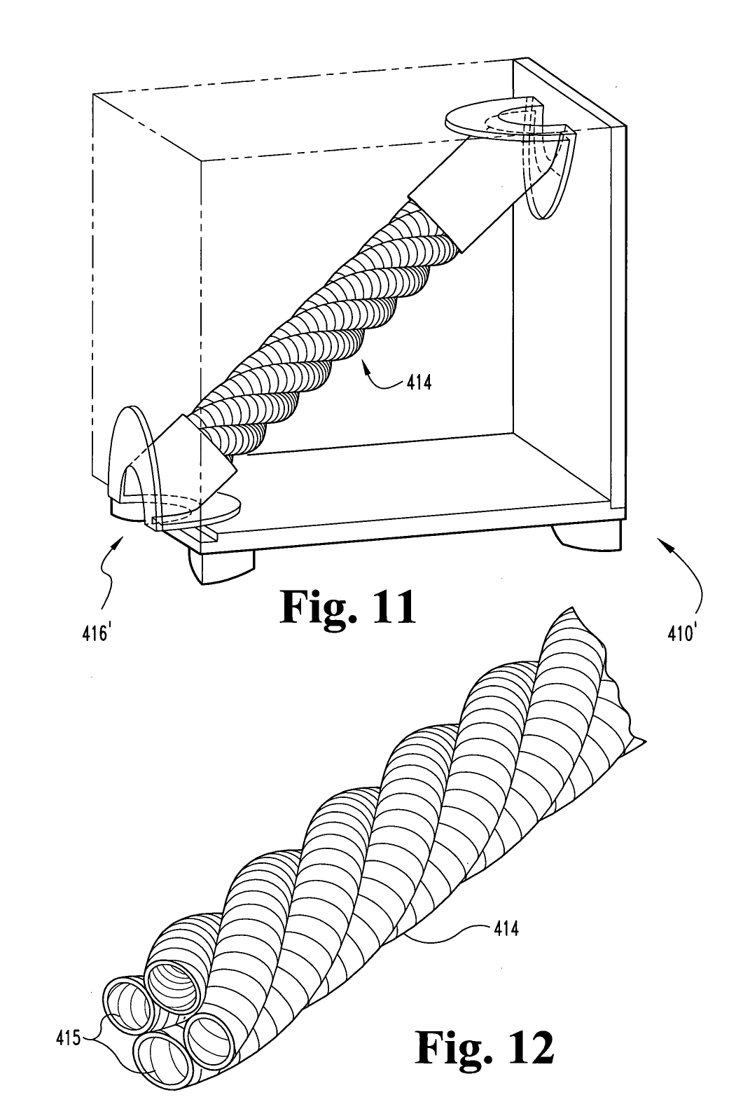

FIGS. 10-12 illustrate fourth and fifth embodiments of the present invention, a vented loudspeaker 410 includes a generally linear port channel 414 extending diagonally from one of the lower corners of the speaker box 412 toward the opposing upper corner. In the embodiment of FIG. 10, the port channel 414 is comprised of a plurality of air channels 415 helically wound about a central (preferably linear) axis extending from an aperture 416 formed in one of the front lower end corners diagonally toward an opposite rear upper end corner. The port channel 414 may alternately begin and end in any convenient diagonal corner pair. The port opening 416 may be formed at the 3-way corner junction defined by the intersection of the right side wall, the front wall and the bottom wall 410C, 410A, 410B, to take advantage of the longest linear port channel dimension 414 for a given speaker box size and offset distance from an interior wall of the enclosure 412. In a fifth alternate embodiment loudspeaker 410′, the helically wound port 414 may extend from an aperture 416′ formed in the center front lower corner diagonally toward the center rear upper corner.

While the invention has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nearly infinite number of insubstantial changes and modifications to the above-described embodiments and that it would be impractical to attempt to describe all such embodiment variations in the present specification. Accordingly, it is understood that all changes and modifications that come within the spirit of the invention are desired to be protected.

1. A vented speaker system, comprising in combination:
a rectangular speaker box having a top wall and an opposing bottom wall, a front wall and an opposing back wall, and a pair of opposing sidewalls;
an vent formed in the front wall;
a speaker positioned within the speaker box and mounted to the front wall; and
at least three tubular segments disposed within the speaker box;
wherein the first segment is fluidically connected to the vent;
wherein the first and third segments are oriented substantially parallel to each other;
wherein the second segment is fluidically connected between the first and third segments; and
wherein the second segment intersects the first segment at a non-zero angle.

2. The vented speaker system of claim 1 wherein the speaker box includes an interior corner-to-corner diagonal bisector that defines a maximum interior linear dimension and wherein the maximum interior linear dimension is less than the combined lengths of the at least three tubular segments.

3. The vented speaker system of claim 1 wherein the first segment intersects the speaker box at an angle of between about 35 and about 55 degrees.

4. The vented speaker system of claim 1 wherein the vent provides fluidic communication between the interior of the box and the exterior of the box.

5. A vented speaker, comprising in combination:
an enclosure defining a rectangular parallelepiped and a maximum enclosed linear dimension;
a vent aperture formed in the parallelepiped; and
a folded vent tube extending from the aperture into the enclosure and having a first end and a second end;
wherein the first end is fluidically connected to the vent aperture;
wherein folded vent tube has an effective length greater than that of a line extending between the first and the second end; and
wherein the effective vent tube length is greater than the maximum enclosed linear dimension.

6. The vented speaker of claim 5 wherein the folded vent tube has a zigzag shape defined by a pair of non-collinear parallel segments connected in fluidic communication by a connecting segment; wherein each respective segment defines a respective segment length; and wherein the sum total of respective segment lengths further defines a vent tube length.

7. The vented speaker of claim 5 wherein the folded vent tube includes a plurality of helically wound air conduits.

8. The vented speaker of claim 5 further comprising a sound generator mounted within the enclosure and spaced from the vent tube.

9. The vented speaker of claim 5 wherein the vent tube defines a fluidic conduit into the enclosure.

10. The vented speaker of claim 5 further comprising a plurality of sound generators mounted within the enclosure, wherein each respective sound generator is spaced from the remaining acoustic generators and from the vent tube.

11. The vented speaker of claim 5 wherein the folded vent tube includes a flange operationally connected to the second end of the vent tube.

12. The vented speaker of claim 5 wherein the vent tube intersects the vent aperture at an angle of between about 35 and about 55 degrees.

13. The vented speaker of claim 5 wherein the vent tube intersects the enclosure exactly once.

14. A speaker cabinet, comprising in combination:
a generally rectangular parallelepiped housing;
a speaker mounted within the housing;
a vent port formed through the housing; and
a Z-shaped vent tube operationally connected to the vent port and positioned within the housing.

15. The speaker cabinet of claim 14 wherein the speaker is spaced from the Z-shaped vent tube.

16. The speaker cabinet of claim 14 wherein the Z-shaped vent tube intersects the housing at an angle between about 35 and about 55 degrees.

17. The speaker cabinet of claim 14 wherein the Z-shaped vent tube further comprises a flange connected thereto, wherein the flange is substantially spaced from the housing.

18. The speaker cabinet of claim 14 wherein the Z-shaped vent tube is a conduit for fluidic communication between the interior and the exterior of the housing.

19. A method for increasing the sound output of a vented speaker, comprising the steps of:
a) mounting a speaker within a generally rectangular parallelepiped enclosure;
b) forming a ventilation aperture through the enclosure; and
c) extending a folded tube into the enclosure from the aperture;
wherein the interior of the enclosure fluidically communicates with the exterior of the enclosure through the folded tube.

20. The method of claim 19 wherein the folded tube is Z-shaped; wherein the folded tube comprises three segments; wherein the first and second segments are oriented parallel to one another; wherein the first and third segments are oriented non-parallel to one another; and wherein the third segment is connected between the first and second segments.

21. The method of claim 19 wherein the folded tube further comprises a flange operationally connected to the folded tube and wherein the flange does not intersect the generally rectangular parallelepiped enclosure.

22. The method of claim 20 wherein the folded tube further comprises a flange operationally connected to the folded tube and wherein the flange does not intersect the generally rectangular parallelepiped enclosure.

23. The method of claim 19 wherein the folded tube further comprises a plurality of helically wound air conduits.

24. A speaker cabinet, comprising in combination:
a generally rectangular parallelepiped housing;
a speaker mounted within the housing;
a vent port formed through the housing; and
a folded vent tube operationally connected to the vent port and positioned within the housing.

25. A speaker cabinet, comprising in combination:
a generally rectangular parallelepiped housing defining an interior volume;
a speaker mounted within the housing;
a vent port formed through the housing; and
a plurality of helically wound air conduits fluidically connecting the vent port to the interior volume.

26. An enclosure defining a rectangular parallelepiped and a maximum enclosed linear dimension;
an vent aperture formed in the parallelepiped; and
a folded vent tube extending from the aperture into the enclosure and having a first end and a second end;
wherein the first end is fluidically connected to the vent aperture;
wherein folded vent tube has an effective length greater than that of a line extending between the first and the second end; and
wherein the effective vent tube length is greater than the maximum enclosed linear dimension.

27. An enclosure defining an a rectangular parallelepiped and a maximum enclosed linear dimension;
a vent aperture formed through the parallelepiped;
a vent tube extending through the aperture into the enclosure and having a first and a second end;
wherein the vent tube further comprises a plurality of helically wound air conduits;
wherein the first end is fluidically connected to the vent aperture;
wherein the folded vent tube has an effective length greater than that of a line extending between the first and second end; and
wherein the effective length of the vent tube is greater than the maximum enclosed linear dimension.

28. The enclosure of claim 27 wherein the vent tube further comprises 2 helically wound air conduits.

29. The enclosure of claim 27 wherein the vent tube further comprises three air conduits.

30. The enclosure of claim 27 wherein the vent tube further comprises four air conduits.

31. The enclosure of claim 27 wherein the vent tube further comprises eight air conduits.
